(19) United States
(12) Patent Application Publication
(10) Pub. No.: US 2012/0057824 A1
(43) Pub. Date: Mar. 8, 2012

(54) OPTICAL CONNECTOR AND OPTICAL COMMUNICATION SYSTEM

(75) Inventor: Seiji KATOH, Sakura-shi (JP)

(73) Assignee: FUJIKURA LTD., Tokyo (JP)

(21) Appl. No.: 13/192,098

(22) Filed: Jul. 27, 2011

(30) Foreign Application Priority Data
Sep. 3, 2010 (JP) 2010-198121

(51) Int. Cl. G02B 6/38

(52) U.S. Cl. 385/71

(57) ABSTRACT

An optical connector that is optically connected to another optical connector inside a connector adapter includes: a housing that receives a ferrule; and plural first keys that protrude from an outer surface of the housing and that extends in a coupling direction. Here, at least one of the plural first keys is disposed outside two points corresponding to both ends in the width direction of a key groove of a standardized connector adapter. At least one groove formed between the plural first keys is disposed inside two points corresponding to both ends in the width direction of a key of a standardized optical connector.

### BACKGROUND OF THE INVENTION

1. Field of the Invention

The present invention relates to an optical connector and an optical communication system, and more particularly, to an optical connector that is optically connected to another optical connector inside a connector adapter and an optical communication system that optically connects optical fibers using the optical connector.

Priority is claimed on Japanese Patent Application No. 2010-198121, filed Sep. 3, 2010, the content of which is incorporated herein by reference.

2. Description of the Related Art

With the recent spread and improvement of information and communication technology such as the Internet, an optical communication system that can transmit data at a high speed with high capacity has been constructed. In this optical communication system, with the increase in the number of cores and density of an optical fiber cable, optical fibers have been optically connected in bulk using a multi-core optical connector. In addition, with the spread of the optical communication system, the requirement for a decrease in cost of the multi-core optical connector has increased.

An optical connector engaging with a connector adapter or the like in a push-on manner, for example, an MPO type optical connector (“F13 TYPE MULTI_CORE OPTICAL FIBER CONNECTOR C 5982: 1997”, JIS Handbook Electronic Test Method/Optoelectronics part, published by Japanese Standards Association, Apr. 24, 1998) which is an F13 type optical connector defined in the JIS C5982, has been used as the multi-core optical connector.

FIG. 10 is an entire perspective view illustrating an optical connector 101 standardized with the JIS. FIG. 11 is a front view illustrating the optical connector 101 as viewed from direction C in FIG. 10. FIG. 12 is a front view illustrating a connector adapter 107 according to the related art as viewed from direction D in FIG. 10.

The optical connector 101 is optically connected to another optical connector by connector coupling inside the connector adapter 107. The optical connector 101 has a structure in which a ferrule attached to an end of an optical fiber 11 is built in and supported by a housing 102 and a coupling 3 is disposed around the housing 102 so as to move forward and rearward relative to the housing 102. A key 105 protruding and extending in the front and rear direction is formed on an outer surface of the housing 102.

The connector adapter 107 is formed in a tubular shape having a rectangular section out of a resin or the like and an insertion hole 171 into which the optical connector 101 is inserted is formed therein. A key groove 106 into which the key 105 is inserted is formed in the inner wall of the insertion hole 171 so as to prevent the improper insertion or the positional deviation of the optical connector 101.

The protruding height of the key 105 and the key width thereof are defined in the JIS. In the optical connector 101, the defined protruding height of the key 105 is about 0.7 mm and the key width represented by reference sign S1 is about 3.0 mm (see FIG. 11). The key groove width (represented by reference sign S2) having a shape fitting to the key 105 is about 3.5 mm (see FIG. 12).

As means for further preventing improper insertion of the optical connector, JP-A-10-206689 discloses an optical connector that can prevent the improper insertion of the optical connector into a connector adapter by forming the connector adapter with a structure capable of regulating the deformation of the connector adapter.

In the JIS, 12 cores are considered as the number of cores, but 24-core and 48-core MPO connectors (hereinafter, referred to as 24 MPO and 48 MPO, respectively) in which optical fibers are two-dimensionally arranged have been developed. The basic structures of the 24 MPO and the 48 MPO are based on an MPO connector (JIS F13 type) and the coupling state is generally maintained by mounting a spring having a high spring pressure in the housing.

However, in order to realize the physical contact (PC) coupling of end faces of the optical fibers, 24 MPO and 48 MPO connectors having a spring defined in the JIS built therein, which does not provide a sufficient spring pressure, are known. In this case, there is a problem in that the 24 and 48 MPO connectors having a spring pressure defined in the JIS and the 24 and 48 MPO connectors having a high spring pressure cannot be visually distinguished from each other.

Accordingly, U.S. Pat. No. 7,182,523 discloses an optical connector in which a thinner key is additionally formed at the end of a key formed on an outer surface of a housing and a key is additionally formed on the outer surface opposite to the outer surface having the key formed thereon. Accordingly, it is possible to prevent an optical connector having a high spring pressure from being erroneously coupled to a standard MPO connector and to visually distinguish the connectors on the basis of the protruding position of the end of the key. However, such an optical connector is not simple in structure, and the mold for the optical connector is complicated, thereby incurring a high cost.

### SUMMARY OF THE INVENTION

The invention is made in consideration of the above-mentioned problems. A goal of the invention is to provide an optical connector that can prevent erroneous connection to a standardized optical connector and that can be manufactured with low cost and an optical communication system in which optical fibers are optically connected to each other using the optical connector.

(1) According to an aspect of the invention, there is provided an optical connector that is optically connected to another optical connector inside a connector adapter, including: a housing that receives a ferrule; and a plurality of first keys that protrude from an outer surface of the housing and that extends in a coupling direction. Here, at least one of the plurality of first keys is disposed outside two points corresponding to both ends in the width direction of a key groove of a standardized connector adapter, and at least one groove formed between the plurality of first keys is disposed inside two points corresponding to both ends in the width direction of a key of a standardized optical connector.

(2) In the optical connector, each of the plurality of first keys may have a visible width equal to or greater than a predetermined value.

(3) In the optical connector, one or more second keys may be formed on the outer surface of the housing opposite to the outer surface on which the plurality of first keys is formed.

(4) According to another aspect of the invention, there is provided an optical communication system in which optical fibers are optically connected to each other using a plurality of the above-mentioned optical connectors.

(5) In the optical communication system, the optical connectors to be identified may differ from each other in the number and/or arrangement of the plurality of first keys.

(6) In the optical communication system, the optical connectors to be identified may differ from each other in the color of a part of the optical connectors.

(7) In the optical communication system, each optical connector may further include a coupling that has a tubular shape surrounding the housing and that can move forward and rearward relative to the housing, and the optical connectors to be identified may differ from each other in the color of the coupling.

According to the above-mentioned configurations, it is possible to prevent an optical connector, other than a standardized optical connector, from being erroneously connected to a standardized connector adapter.

Since the first keys have a shape similar to a key of the standardized optical connector, they can be manufactured with low cost, thereby reducing the manufacturing cost of the optical connector.

Since each of the first keys is formed with a visible width equal to or greater than a predetermined value, it is possible to facilitate the distinction from the standardized optical connector.

When the second key is formed, it is possible to further prevent erroneous connection.

### BRIEF DESCRIPTION OF THE DRAWINGS

FIG. 1 is an entire perspective view illustrating an optical connector according to a first embodiment of the invention.

FIG. 2 is an entire perspective view illustrating the optical connector and a connector adapter according to the first embodiment of the invention.

FIG. 3 is a front view illustrating the shape of a housing of the optical connector as viewed from direction A in FIG. 1.

FIG. 4 is an enlarged view schematically illustrating a key of the housing.

FIG. 5 is a front view illustrating the shape of the connector adapter as viewed from direction B in FIG. 2.

FIG. 6 is an enlarged view schematically illustrating a key groove of the connector adapter.

FIG. 7 shows diagrams schematically illustrating the shapes of keys of optical connectors and key grooves of connector adapters according to second and third embodiments of the invention, respectively.

FIG. 8 shows diagrams schematically illustrating the shapes of keys of optical connectors and key grooves of connector adapters according to Comparative Examples 1 to 3.

FIG. 9 is a front view illustrating an optical connector and a connector adapter according to another embodiment of the invention.

FIG. 10 is an entire perspective view illustrating an example of an optical connector according to the related art.

FIG. 11 is a front view illustrating the optical connector according to the related art as viewed from direction C in FIG. 10.

FIG. 12 is a front view illustrating a connector adapter according to the related art as viewed from direction D in FIG. 10.

### DETAILED DESCRIPTION OF THE INVENTION

### First Embodiment

Hereinafter, a first embodiment of the invention will be described in detail with reference to the accompanying drawings.

An optical connector 1 according to this embodiment employs the structure of an MPO type optical connector (which is an F13 type optical connector defined in the JIS C5982, MPO: Multi-fiber Push On), except for the shape of a key 5 formed in a housing 2 and a spring pressure of a spring built in the housing 2 to be described later.

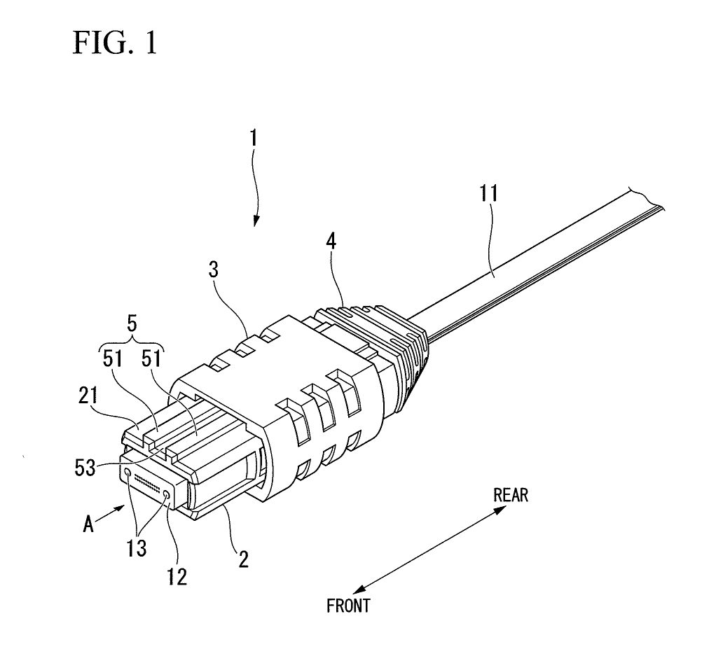

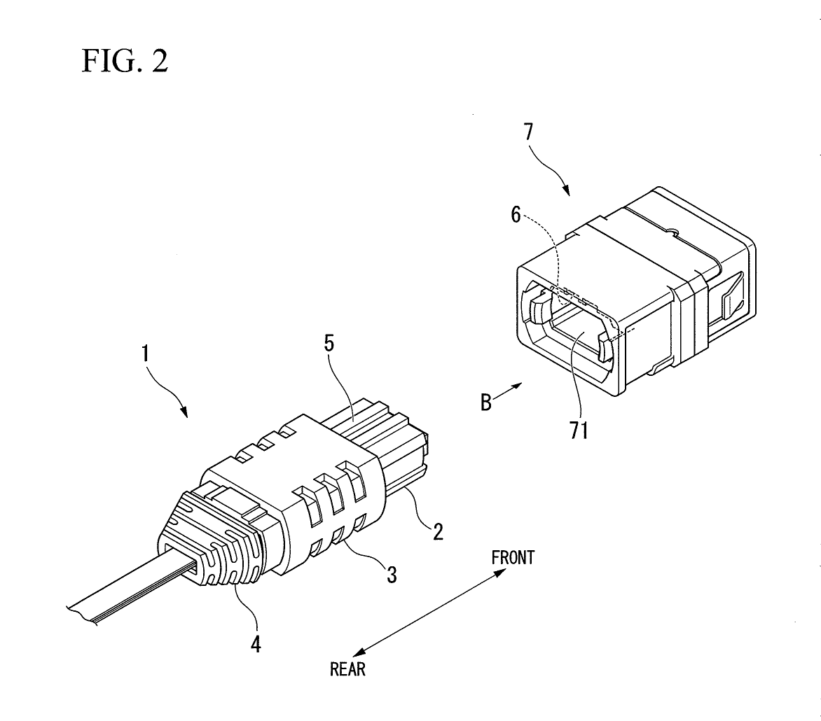

In the following description, the positional relations of elements may be explained with reference to “FRONT” and “REAR” in FIGS. 1 and 2. The “axis direction” of a tubular member means the center axis direction of the member.

As shown in FIG. 1, the optical connector 1 includes a ferrule 12 attached to an end of an optical fiber 11 (which has a shape in which two 12-core optical fiber tapes are superposed in the drawing), a housing 2 receiving and supporting the ferrule 12, a coupling 3 disposed to slide and move in the axis direction of the housing 2, and a boot 4 disposed at the rear end of the housing 2. A spring (not shown in the drawing) is received in the housing 2 in such a manner that it is externally inserted to the optical fiber 11, and urges the ferrule 12 to the front side. The spring pressure of the spring is appropriately determined depending on the number of cores of the optical fiber 11.

Since the housing 2 has the same shape as an optical connector standardized with the JIS (hereinafter, referred to as a standard optical connector) except for the shape of a key 5, a coupling of an existing standard connector can be used.

Two guide holes 13 are formed in the ferrule 12. The positioning of optical connectors to be connected is achieved by inserting common guide pins (not shown in the drawing) into the guide holes.

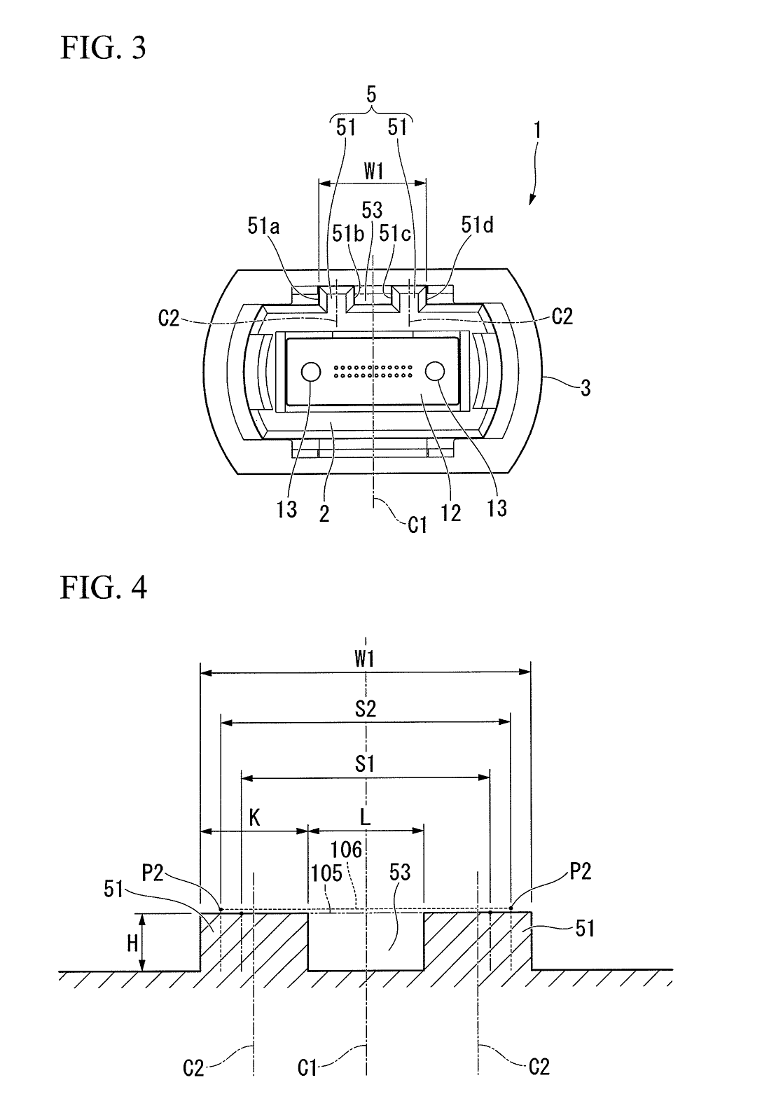

A key 5 is formed in an outer surface 21 of the housing 2. The key 5 protrudes upwardly from the outer surface 21 of the housing 1. As shown in FIG. 3, the key 5 includes two first keys 51 and 51 formed in the coupling direction and a groove 53 is defined by the two first keys 51 and 51.

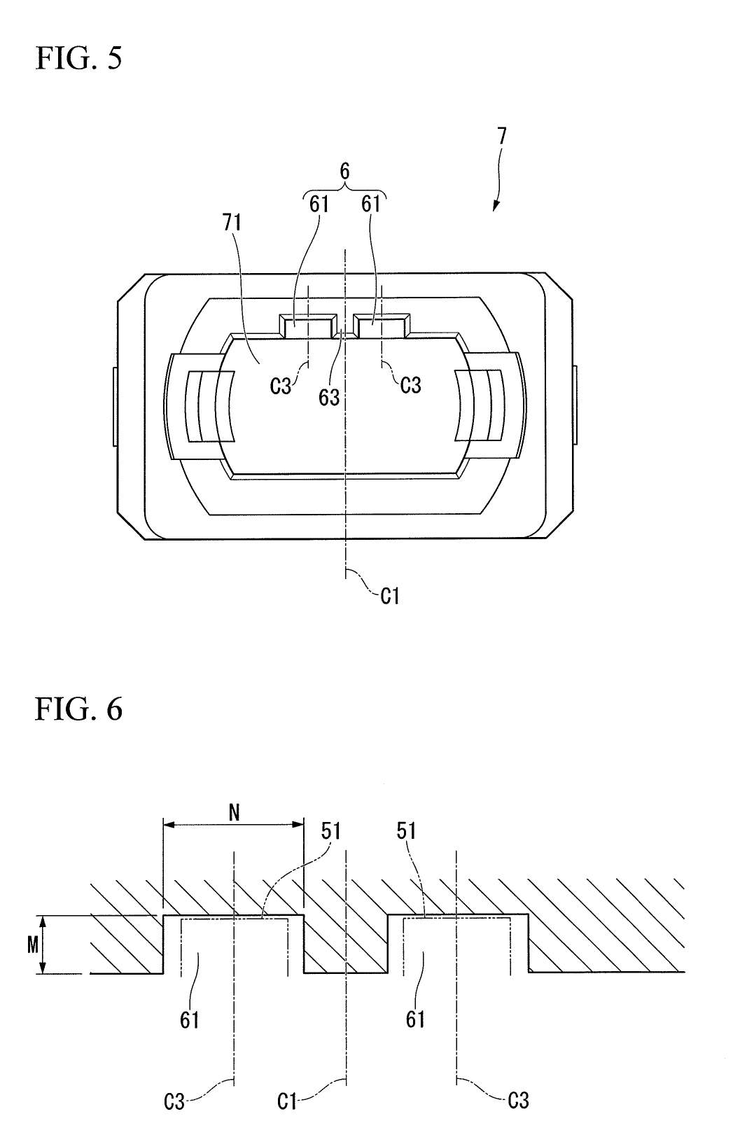

As shown in FIG. 2, an insertion hole 71 into which the optical connector 1 is inserted is formed in a connector adapter 7 which is connected to the optical connector 1. A key groove 6 having a shape fitting to the key 5 is formed on the top surface of the insertion hole 71. As shown in FIG. 5, the key groove 6 includes two first key grooves 61 and 61. A protrusion 63 is defined between the two first key grooves 61 and 61 by the two first key grooves 61 and 61.

The shape of the key 5 in the housing 2 will be described below in detail with reference to FIG. 3 and FIG. 4 which shows an enlargement of the key 5 shown in FIG. 3.

Each of the two first keys 51 and 51 is a long protrusion having a rectangular section and being symmetric about the center line C1 of the housing 2. As described above, the first keys 51 and 51 are formed in the coupling direction (the front and rear direction). The protruding height H of the first key 51 is about 0.7 mm and the width K of the first key 51 is about 1 mm. The width L of the groove 53, that is, the distance between the first keys 51 and 51, is about 1.5 mm. The protruding height H is the same as the standard optical connector.

In FIG. 4, the outline of a key groove 106 (see FIG. 12) of a connector adapter standardized with the JIS (hereinafter, referred to as a standard connector adapter) is indicated by a broken line. Reference S2 represents the width of the standardized key groove 106 and reference sign P2 represents two points corresponding to both ends in the width direction of the key groove 106.

As can be clearly seen from FIG. 4, parts of the first keys 51 and 51 are disposed outside the two points P2 and P2 in the width direction corresponding to both ends in the width direction of the key groove 106 of the standard connector adapter. That is, even when it is intended to insert the optical connector 1 according to this embodiment into the standard connector adapter, the first keys 51 interfere with the key groove 106 and thus insertion is not possible.

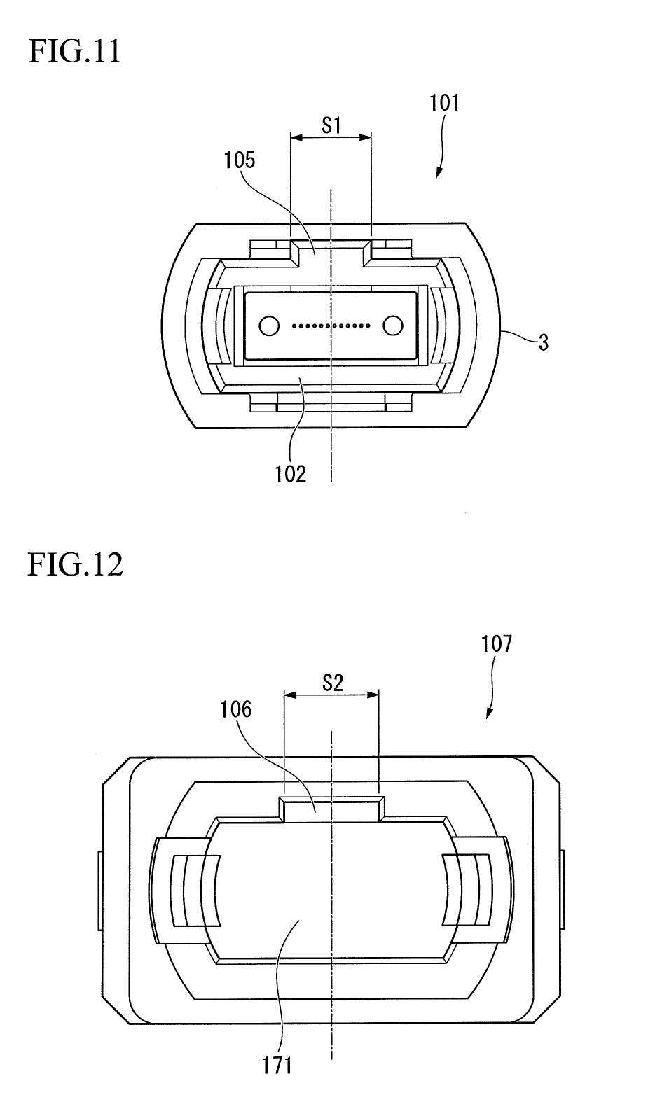

In FIG. 4, the outline of a key 105 (see FIG. 11) of a standardized optical connector is indicated by a two-dot chained line. Reference sign S1 represents the width of the key 105 of the standard optical connector and reference sign P1 represents two points corresponding to both ends in the width direction of the key 105.

As can be clearly seen from FIG. 4, the groove 53 is disposed inside the two points P1 and P1 in the width direction corresponding to both ends in the width direction of the key 105 of the standard optical connector. That is, even when it is intended to insert the standard optical connector into the connector adapter 7 corresponding to the optical connector 1 according to this embodiment, the protrusion 63 of the connector adapter 7 fitting to the groove 53 interferes with the key 105 of the standard optical connector and thus insertion is not possible.

The shape of the key groove 6 of the connector adapter 7 will be described below in detail with reference to FIG. 5 and FIG. 6 which shows the enlargement of the key groove 6 shown in FIG. 5. Each of the two first key grooves 61 and 61 is a long key groove having a rectangular section and being symmetric about the center line C1 of the connector adapter 7. The distance between the center line C1 of the connector adapter and the center line C3 of the first key groove 61 is equal to the distance between the center line C1 of the housing and the center line C2 of the first key 51 (see FIG. 4). Accordingly, when the optical connector 1 is inserted into the connector adapter 7, the first keys 51 and 51 are inserted into the first key grooves 61.

The depth M of the first key groove 61 is about 0.8 mm and the width N of the first key groove 61 is about 1.1 mm, which is greater than the outline of the first key 51 indicated by the one-dot chained line in FIG. 6.

The shape of the key 5 of the optical connector 1 and the shape of the key groove 6 of the connector adapter 7 according to the first embodiment satisfy the following three conditions.

(1) The optical connector 1 cannot be inserted into the connector adapter standardized with the JIS. That is, at least one of the plural first keys has to be disposed outside two points corresponding to both ends in the width direction of the key groove of the standard connector adapter.

(2) The optical connector standardized with the JIS cannot be inserted into the connector adapter 7 fitting to the optical connector 1. That is, at least one of the grooves of the plural first keys has to be disposed inside two points corresponding to both ends in the width direction of the key of the standard optical connector.

(3) They have to be easily visually distinguished from the JIS standard products.

In the optical connector according to this embodiment, since parts of the two first keys 51 and 51 are disposed outside two points in the width direction corresponding to both ends in the width direction of the key groove of the standard connector adapter, it is possible to prevent the optical connector 1 according to this embodiment from being erroneously inserted into the standard connector adapter. Since the groove 53 between the two first keys 51 and 51 is disposed inside two points corresponding to both ends in the width direction of the key 105 of the standard optical connector, it is possible to prevent the standard optical connector from being erroneously inserted into the connector adapter 7 fitting to the optical connector 1 according to this embodiment.

Since the schematic shape of each first key 51 is similar to the shape of the key 105 of the standard optical connector and has a simple structure, it is possible to reduce the manufacturing cost of the optical connector 1.

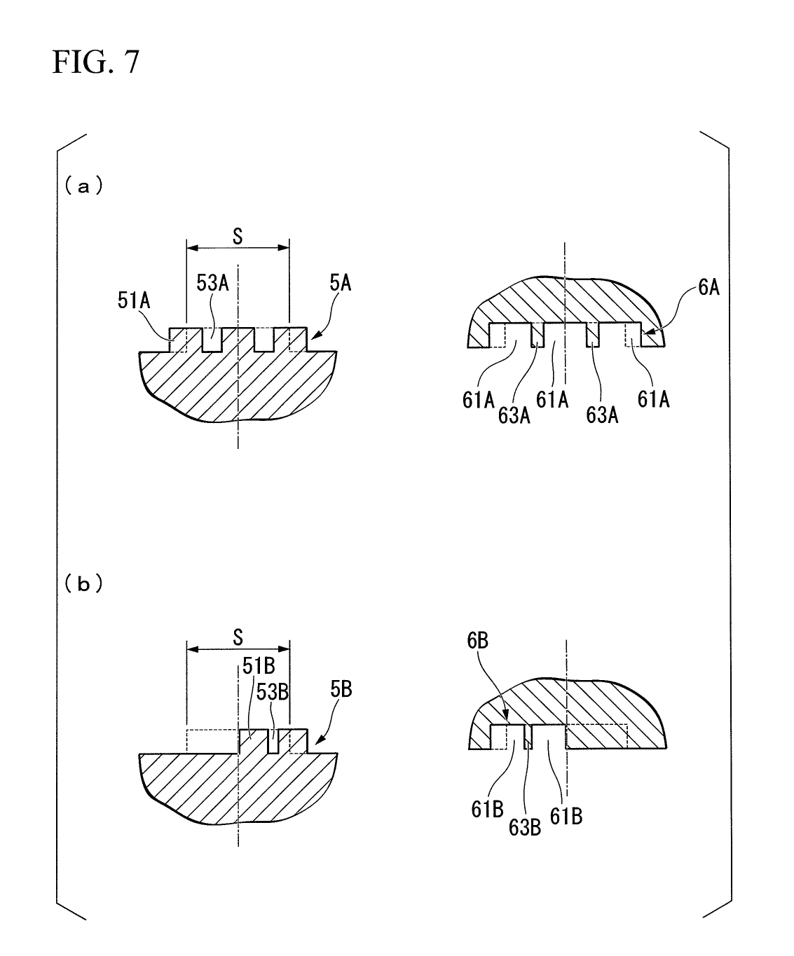

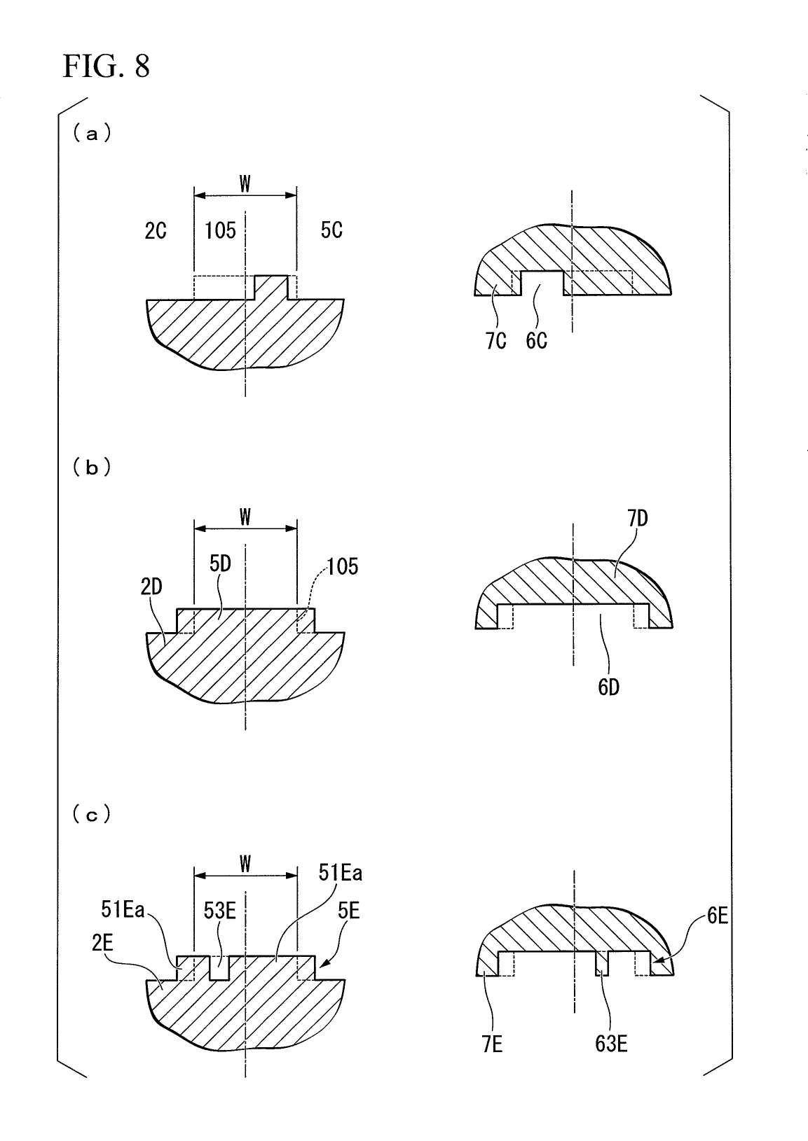

The key shape in the invention is not limited to the shape described in the first embodiment, but any shape can be employed as long as it satisfies the conditions (1) to (3). Optical connectors according to second and third embodiments of the invention will be described below. The embodiments shown in FIG. 7 and comparative examples shown in FIG. 8 have the same configuration as described in the first embodiment, except for the shape of a key and the shape of a key groove. Accordingly, FIG. 7 and FIG. 8 are diagrams illustrating only the shape of a key and the shape of a key groove.

### Second Embodiment

FIG. 7(a) is a diagram schematically illustrating the shape of a key 5A of an optical connector according to the second embodiment and the shape of a key groove 6A of a connector adapter fitting thereto. The outline of the key of the standard optical connector (the key groove of the standard connector adapter) is indicated by a broken line.

The key 5A includes three first keys 51A, 51A, and 51A and two grooves 53A and 53A. The three first keys 51A, 51A, and 51A have the same width and are symmetric about the center line of the housing.

Parts of the outermost two first keys 51A and 51A among the three first keys 51A, 51A, and 51A are disposed outside the outline of the key of the standard optical connector (the key groove of the standard connector adapter) indicated by a broken line. Accordingly, it is possible to prevent the optical connector according to this embodiment from being erroneously inserted into the standard connector adapter. Protrusions 63A and 63A defined between first key grooves 61A, 61A, and 61A of the connector adapter according to this embodiment are disposed inside the outline of the standard optical connector. Accordingly, it is possible to prevent the standard optical connector from being erroneously inserted into the connector adapter according to this embodiment.

### Third Embodiment

FIG. 7(b) is a diagram schematically illustrating the shape of a key 5B of an optical connector according to the third embodiment and the shape of a key groove 6B of a connector adapter fitting thereto.

The key 5B of a housing 2B includes two first keys 51B and 51B and a groove 53B. The two first keys 51B and 51B have the same width. The first keys 51B and 51B constituting the key 5B according to the third embodiment are not symmetric about the center line of the housing, unlike the key 5A according to the second embodiment. Specifically, the first key 51B is disposed in the vicinity of the center line of the housing and the first key 51B is disposed apart from the center line. A part of the first key 51B disposed apart from the center line is disposed outside the outline of the standard optical connector indicated by a broken line.

A protrusion 63B of a key groove 6B of the connector adapter according to this embodiment is disposed inside the outline of the standard optical connector.

Accordingly, it is possible to prevent the optical connector according to this embodiment from being erroneously inserted into the standard connector adapter. It is also possible to prevent the standard optical connector from being erroneously inserted into the connector adapter according to this embodiment.

### Comparative Example 1

FIG. 8(a) is a diagram schematically illustrating the shape of a key 5C of an optical connector according to Comparative Example 1 and the shape of a key groove 6C of a connector adapter fitting thereto.

The key 5C of the optical connector according to Comparative Example 1 has a width smaller than the width of the key 105 of the standard optical connector indicated by a broken line and is disposed inside the outline of the key 105.

In the connector adapter according to Comparative Example 1, since the standard optical connector cannot be inserted into the key groove 6C, it is possible to prevent erroneous insertion. However, since the optical connector according to Comparative Example 1 can be inserted into the standard connector adapter, it is not possible to prevent erroneous insertion.

### Comparative Example 2

FIG. 8(b) is a diagram schematically illustrating the shape of a key 5D of an optical connector according to Comparative Example 2 and the shape of a key groove 6D of a connector adapter fitting thereto.

The key 5D of the optical connector according to Comparative Example 2 has a width larger than the width of the key 105 of the standard optical connector indicated by a broken line and a part thereof is disposed outside the outline of the key 105.

According to Comparative Example 2, since the optical connector according to Comparative Example 2 having the key 5D formed therein cannot be inserted into the standard connector adapter, it is possible to prevent erroneous insertion. However, since the standard optical connector can be inserted into the connector adapter according to Comparative Example 2 having the key groove 6D formed therein, it is not possible to prevent erroneous insertion.

### Comparative Example 3

FIG. 8(c) is a diagram schematically illustrating the shape of a key 5E of an optical connector according to Comparative Example 3 and the shape of a key groove 6E of a connector adapter fitting thereto.

A part of the key 5E of the optical connector according to Comparative Example 3 is disposed outside the outline of the key 105 of the standard optical connector indicated by a broken line. A protrusion 63E of the key groove 6E is disposed inside the outline of the key 105. Accordingly, similarly to the first embodiment, it is possible to prevent erroneous insertion. However, since the shape of the key 5E is similar to the shape of the key 105 of the standard optical connector and is thus difficult to visually distinguish therefrom, it is not a suitable shape.

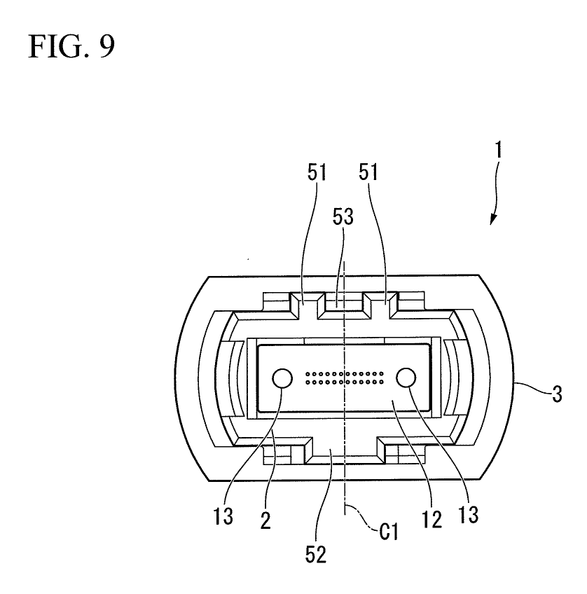

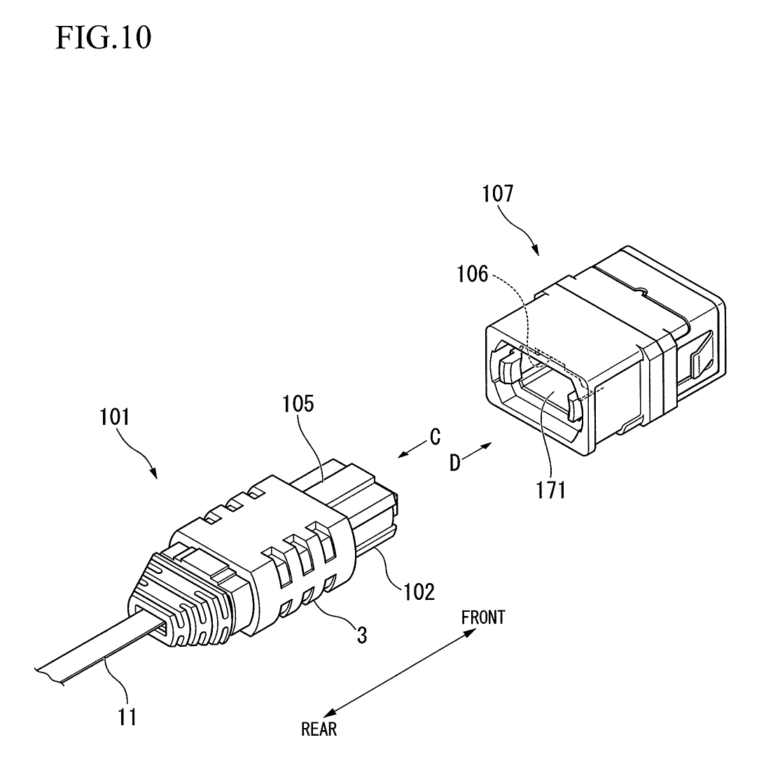

Plural first keys 51 may be formed on an outer surface of the housing and a second key 52 may be formed on the outer surface opposite to the outer surface on which the first keys 51 are formed. FIG. 9 shows a housing 2F having the second key 52 formed therein. By forming the second key 52, it is possible to lower the possibility of erroneous insertion.

### Optical Communication System

The invention may be employed by an optical communication system (optical line) such as FTTH and LAN using an optical fiber. In the optical communication system, plural types of optical fibers such as 4-core, 8-core, 12-core, and 24-core optical fiber tapes may be used as a multi-core optical fiber tape. In this case, in order to identify the different optical fibers, the optical connectors according to the different embodiments may be applied to the optical connectors to be identified.

For example, by applying the optical connector according to the first embodiment (in which the number of first keys is 2) to a 4-core optical fiber tape and applying the optical connector according to the second embodiment (in which the number of first keys is 3) to an 8-core optical fiber tape, it is possible to identify the types of the optical connectors on the basis of the number of first keys.

Otherwise, the types of the optical connectors may be identified by changing the color of a part (for example, the housing) of the optical connectors and the corresponding connector adapter. For example, by changing the color of the housing depending on the spring pressure of the optical connector, it is possible to prevent erroneous insertion. Regarding the place of which the color in the optical connector should be changed, it is preferable in view of easy identification that the color of the coupling be changed.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

1. An optical connector that is optically connected to another optical connector inside a connector adapter, comprising:
a housing that receives a ferrule; and
a plurality of first keys that protrude from an outer surface of the housing and that extends in a coupling direction,
wherein at least one of the plurality of first keys is disposed outside two points corresponding to both ends in the width direction of a key groove of a standardized 10 connector adapter, and
wherein at least one groove formed between the plurality of first keys is disposed inside two points corresponding to both ends in the width direction of a key of a standardized optical connector,

2. The optical connector according to claim 1, wherein each of the plurality of first keys has a visible width equal to or greater than a predetermined value.

3. The optical connector according to claim 1, wherein, one or more second keys are formed on the outer surface of the housing opposite to the outer surface on which the plurality of first keys are formed.

4. The optical connector according to claim 2, wherein one or more second keys are formed on the outer surface of the housing opposite to the outer surface on which the plurality of first keys are formed.

5. An optical communication system in which optical fibers are optically connected to each other using a plurality of the optical connectors according to claim 1.

6. The optical communication system according to claim 5, wherein the optical connectors to be identified differ from each other in the number and/or arrangement of the plurality of first keys.

7. The optical communication system according to claim 5, wherein the optical connectors to be identified differ from each other in the color of a part of the optical connectors.

8. The optical communication system according to claim 6, wherein the optical connectors to be identified differ from each other in the color of a part of the optical connectors.

9. The optical communication system according to claim 5, wherein each optical connector further includes a coupling that has a tubular shape surrounding the housing and that can move forward and rearward relative to the housing, and
wherein the optical connectors to be identified differ from each other in the color of the coupling.

10. The optical communication system according to claim 6, wherein each optical connector further includes a coupling that has a tubular shape surrounding the housing and that can move forward and rearward relative to the housing, and
wherein the optical connectors to be identified differ from each other in the color of the coupling.

11. An optical communication system in which optical fibers are optically connected to each other using a plurality of the optical connectors according to claim 2.

12. An optical communication system in which optical fibers are optically connected to each other using a plurality of the optical connectors according to claim 3.

13. An optical communication system in which optical fibers are optically connected to each other using a plurality of the optical connectors according to claim 4.
